(19) United States
(12) Patent Application Publication
(10) Pub. No.: US 2026/0113511 A1
(43) Pub. Date: Apr. 23, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Takehiro AOSHIMA, Tokyo (JP); Masaya KAWAMURA, Tokyo (JP); Yusuke SHINOHARA, Tokyo (JP); Hironori DOI, Tokyo (JP); Byeongseon PARK, Tokyo (JP)

(21) Appl. No.: 19/291,420

(22) Filed: Aug. 5, 2025

(30) Foreign Application Priority Data
Oct. 18, 2024 (JP) 2024-184370

(51) Int. Cl. H04N 21/488; G06V 20/70

(52) U.S. Cl. CPC H04N 21/4884; G06V 20/70

(57) ABSTRACT

An information processing apparatus according to the present application includes an acquisition unit that acquires explanatory information describing content of a moving image, a generation unit that generates subtitles to be applied to a moving image (for example, subtitles indicating an imaging object of a moving image, subtitles indicating a state of mind of an imaging object of a moving image, subtitles indicating a situation of an imaging object of a moving image, and the like) based on the explanatory information acquired by the acquisition unit, and an application unit that applies the subtitles generated by the generation unit to the moving image.

### CROSS-REFERENCE TO RELATED APPLICATIONS

The present application claims priority to and incorporates by reference the entire contents of Japanese Patent Application No. 2024-184370 filed in Japan on Oct. 18, 2024.

### BACKGROUND OF THE INVENTION

### 1. Field of the Invention

The present invention relates to an information processing apparatus, an information processing method, and a non-transitory computer readable storage medium.

### 2. Description of the Related Art

Conventionally, a technology related to image processing performed by recognizing an object included in an image has been provided. As an example of such a technology, a technique of adding subtitles to a moving image using a sound detection result in the moving image is known.

However, in the above-described technology, it is not always possible to generate and apply appropriate subtitles for content of the moving image.

For example, in the above-described technology, text data based on voice recognition from the moving image is merely added, and it is not always possible to generate and apply appropriate subtitles for the content of the moving image.

### SUMMARY OF THE INVENTION

It is an object of the present invention to at least partially solve the problems in the conventional technology.

An information processing apparatus according to the present application includes an acquisition unit that acquires explanatory information describing content of a moving image, a generation unit that generates subtitles to be applied to a moving image based on the explanatory information acquired by the acquisition unit, and an application unit that applies the subtitles generated by the generation unit to the moving image.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to an embodiment;

FIG. 2 is a diagram illustrating a configuration example of an information processing apparatus 10 according to the embodiment;

FIG. 3 is a diagram illustrating an example of a moving image information database 31;

FIG. 4 is a flowchart illustrating an example of a procedure of the information processing according to the embodiment; and

FIG. 5 is a hardware configuration diagram illustrating an example of a computer that implements the functions of the information processing apparatus 10.

### DETAILED DESCRIPTION OF THE PREFERRED EMBODIMENTS

Hereinafter, modes (hereinafter, referred to as an “embodiment”) for implementing an information processing apparatus, an information processing method, and a non-transitory computer readable storage medium according to the present application will be described in detail with reference to the drawings. Note that the information processing apparatus, the information processing method, and the non-transitory computer readable storage medium according to the present application are not limited by the embodiment. In the following embodiments, the same parts are denoted by the same reference numerals, and redundant description will be omitted.

### 1. Embodiment

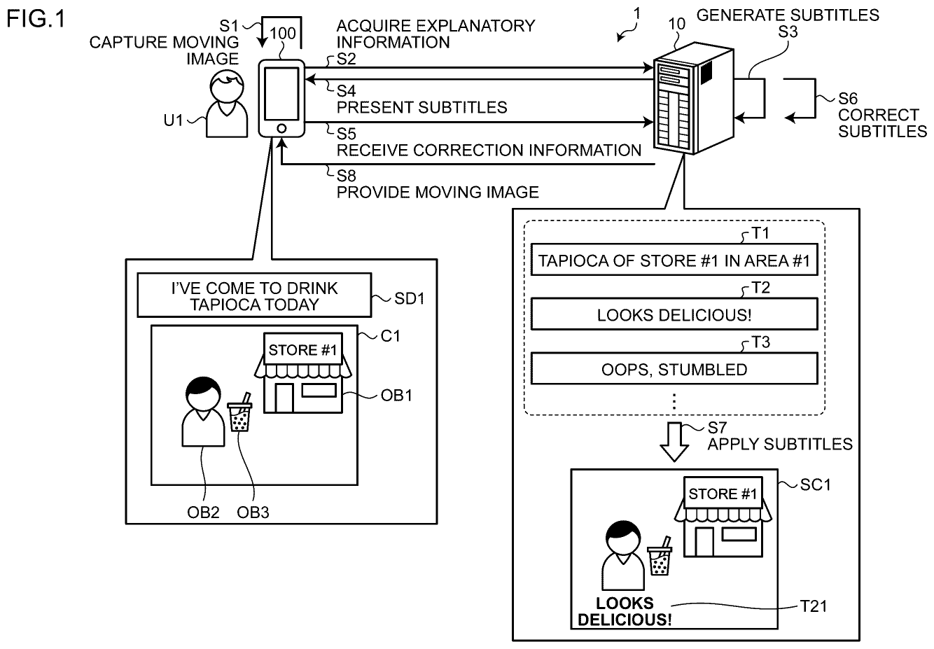

Information processing realized by the information processing apparatus or the like of the present embodiment will be described with reference to FIG. 1. FIG. 1 is a diagram illustrating an example of information processing according to the embodiment. Note that, in FIG. 1, information processing and the like according to the embodiment are realized by an information processing apparatus 10 which is an example of the information processing apparatus according to the present application.

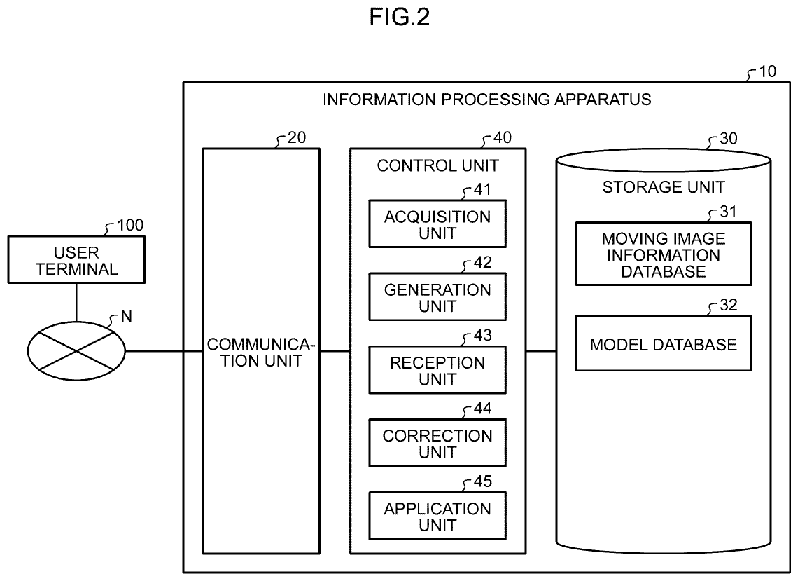

As illustrated in FIG. 1, an information processing system 1 according to the embodiment includes the information processing apparatus 10 and a user terminal 100. The information processing apparatus 10 and the user terminal 100 are communicably connected to each other in a wired or wireless manner via a network N (see, for example, FIG. 2). The network N is, for example, a wide area network (WAN) such as the Internet. Note that the information processing system 1 illustrated in FIG. 1 may include a plurality of information processing apparatuses 10 and a plurality of user terminals 100.

The information processing apparatus 10 illustrated in FIG. 1 is an information processing apparatus that performs information processing according to the embodiment, and is realized by, for example, a server device, a cloud system, or the like. For example, the information processing apparatus 10 receives a moving image from a user (in other words, a provider of the moving image) and provides a moving image editing service for applying subtitles to the received moving image.

Note that the information processing apparatus 10 may have a function as a web server that provides a web site related to the moving image editing service. Furthermore, the information processing apparatus 10 may be a device that distributes information to be displayed on an application related to the moving image editing service installed in the user terminal 100 to the user terminal 100. Furthermore, the information processing apparatus 10 may be a server that distributes application data itself. Furthermore, the information processing apparatus 10 may function as a distribution apparatus that distributes control information to the user terminal 100. Here, the control information is described in, for example, a script language such as JavaScript (registered trademark) or a style sheet language such as Cascading Style Sheets (CSS). Note that the application itself distributed from the information processing apparatus 10 may be regarded as the control information.

The user terminal 100 illustrated in FIG. 1 is an information processing apparatus used by a user. For example, the user terminal 100 is realized by a smartphone, a tablet terminal, a notebook personal computer (PC), a desktop PC, a mobile phone, a personal digital assistant (PDA), or the like. Note that the example illustrated in FIG. 1 illustrates a case where the user terminal 100 is a smartphone used by the user.

In addition, the user terminal 100 displays information provided by the information processing apparatus 10 by a web browser or an application. Note that, in a case where the user terminal 100 receives control information for realizing the information display processing from the information processing apparatus 10 or the like, the display processing is realized according to the control information.

Hereinafter, information processing executed by the information processing apparatus 10 will be described with reference to FIG. 1. Note that, in the following description, it is assumed that the user terminal 100 is used by the user (user U1) identified by the user ID “UID #1”. In addition, in the following description, the user terminal 100 may be regarded as the same as the user U1. That is, hereinafter, the user U1 can be read as the user terminal 100.

First, the user U1 captures a moving image using the user terminal 100 (step S1). Here, in the example of FIG. 1, it is assumed that the user U1 visits a store #1 located in an area #1 and images a moving image C1 including an imaging object OB1 (store #1), an imaging object OB2 (user U1), an imaging object OB3 (tapioca) held by the user U1, and the like.

Subsequently, the information processing apparatus 10 acquires the moving image C1 and explanatory information describing the content of the moving image C1 from the user terminal 100 via the moving image editing service (step S2). For example, the information processing apparatus 10 acquires text information indicating explanatory notes (caption) of the moving image C1 input by the user U1 as the explanatory information. Here, the explanatory notes may include, for example, the purpose of capturing the moving image C1, information indicating the imaging object, and information regarding the imaging object and the user U1 (for example, attribute information).

In addition, the information processing apparatus 10 acquires, as the explanatory information, position information measured by the user terminal 100 using a global positioning system (GPS) or the like at the time of imaging the moving image C1 (that is, position information at the time of imaging the moving image C1). Furthermore, the information processing apparatus 10 may acquire additional information based on the position information at the time of imaging the moving image C1.

Here, the additional information may include information of a facility or a store (for example, the information includes, but is not limited to, detailed information regarding products and menus described on a website of the store, evaluation of the store by an evaluation site, a social networking service (SNS), word-of-mouth information from a user posted on a website, and the like) related to position information separately acquired from a server device or the like not illustrated. Furthermore, as another example of the additional information, event information (for example, the information includes, but is not limited to, information regarding a schedule and implementation contents described on a website of the event, evaluation of the event by an evaluation site, word-of-mouth information from a user posted on an SNS or a website, and the like) that has been performed at a place indicated by position information at the time of imaging the moving image C1, which is separately acquired from a server device or the like not illustrated, may be included.

Furthermore, the information processing apparatus 10 acquires text information indicating a voice included in the moving image C1 as explanatory information. As an example, the information processing apparatus 10 acquires text information indicating a voice SD1 uttered by the user U1 as the explanatory information. Note that such text information may be acquired by the user terminal 100 from the voice SD1 using any voice recognition technology. Furthermore, such text information may be acquired by the information processing apparatus 10 from the voice SD1 using any voice recognition technology.

In addition, the information processing apparatus 10 acquires an analysis result obtained by analyzing the moving image C1 using any image analysis technology as explanatory information. Here, the analysis result may include, for example, text information indicating an expression of the imaging object (for example, the user U1), an operation of the imaging object, a physical body (for example, the imaging object OB3) held by the imaging object, a character string included in the moving image C1 (for example, the character string “store #1” indicated by the signboard of the store #1), and the like. Note that such an analysis result may be obtained by the user terminal 100 from the moving image C1 using any image analysis technology. Furthermore, such an analysis result may be obtained by the information processing apparatus 10 from the moving image C1 using any image analysis technology.

Furthermore, the information processing apparatus 10 may determine the probability regarding the acquired additional information (described above) on the basis of the above-described “text information indicating the voice SD1” and “analysis result of the moving image C1”, and determine whether or not to use the additional information in processing to be described later. For example, in a case where the information processing apparatus 10 acquires a tapioca store which is a specific store related to the position information as the additional information, the information processing apparatus 10 determines a value indicating the probability with respect to the moving image of the information regarding the tapioca store acquired as the additional information on the basis of “text information indicating the voice SD1” or “analysis result of the moving image C1”. Then, in a case where a value indicating the probability is equal to or greater than a predetermined threshold value, the information processing apparatus 10 may determine to use the additional information for processing to be described later (for example, the value indicating the probability increases, if the voice in the moving image C1 includes a voice of “I've come to the tapioca store xx”, text of “tapioca” is analyzed as a result of the analysis of the moving image C1, or the actual tapioca appears in the moving image C1).

Subsequently, the information processing apparatus 10 generates subtitles to be applied to the moving image C1 on the basis of the explanatory information of the moving image C1 (step S3). For example, the information processing apparatus 10 generates subtitles to be applied to the moving image C1 by using the explanatory information of the moving image C1 and the model #1 learned to generate an answer to an input question.

As a specific example, the information processing apparatus 10 generates subtitles by inputting, to the model #1, explanatory information of the moving image C1, a rule defining generation of subtitles indicating information regarding an imaging object included in the moving image C1, and an instruction sentence for instructions to generate the subtitles on the basis of the explanatory information of the moving image C1 according to the rule. As an example, the information processing apparatus 10 generates subtitles T1 “tapioca of the store #1 in the area #1” indicating the information related to the imaging object OB3 on the basis of the explanatory information, such as the positional information (for example, area #1) at the time of imaging the moving image C1, the text information indicating the voice SD1 uttered by the user U1, the character string “store #1” indicated by the signboard of the store #1, the text information “I've come to drink tapioca today” indicating the voice SD1, and the like.

Furthermore, the information processing apparatus 10 may generate subtitles indicating information regarding the imaging object by using the above-described additional information in addition to the explanatory information of the moving image C1. As an example, the information processing apparatus 10 may generate subtitles (not illustrated) of “Today, I've come to the tapioca store xx known for the popular mango tapioca juice” on the basis of explanatory information such as text information indicating the voice SD1 “I've come to drink tapioca today” and the additional information.

In addition, the information processing apparatus 10 generates subtitles by inputting, to the model #1, explanatory information of the moving image C1, a rule defining generation of subtitles indicating a state of mind of an imaging object included in the moving image C1, and an instruction sentence for instructions to generate the subtitles on the basis of the explanatory information of the moving image C1 according to the rule. As an example, the information processing apparatus 10 generates subtitles T2 “looks delicious!” indicating the state of mind of the imaging object OB2 on the basis of the explanatory information such as the expression of the imaging object OB2 and the text information “I've come to drink tapioca today”indicating the voice SD1.

In addition, the information processing apparatus 10 generates subtitles by inputting, to the model #1, explanatory information of the moving image C1, a rule defining generation of subtitles indicating a situation of an imaging object included in the moving image C1, and an instruction sentence for instructions to generate the subtitles on the basis of the explanatory information of the moving image C1 according to the rule. As an example, the information processing apparatus 10 generates subtitles T3 “Oops, stumbled” indicating a situation of the imaging object OB2 on the basis of the explanatory information indicating an operation of the imaging object OB2 (for example, “Oops, stumbled”).

Note that the information processing apparatus 10 may generate “I've come to the store #1” as the subtitles indicating the situation of the imaging object on the basis of the positional information (for example, area #1) at the time of imaging the moving image C1 or the explanatory information such as the character string “store #1” indicated by the signboard of the store #1.

Furthermore, the information processing apparatus 10 may generate subtitles indicating an atmosphere around the imaging object as the subtitles indicating the situation of the imaging object. For example, the information processing apparatus 10 may generate subtitles indicating the degree of congestion around the imaging object according to the number of people included in the moving image C1. As an example, in a case where the number of people included in the moving image C1 is equal to or larger than a predetermined threshold value (that is, when it is crowded), the information processing apparatus 10 generates subtitles indicating congestion “it's crowded” or subtitles indicating an onomatopoeia such as “hustle and bustle”. Furthermore, in a case where the number of people included in the moving image C1 is less than a predetermined threshold value (that is, when it is not crowded), the information processing apparatus 10 generates subtitles indicating congestion “it's not crowded” or subtitles indicating an onomatopoeia such as “empty and empty”.

Furthermore, the information processing apparatus 10 may generate subtitles indicating the degree of excitement around the imaging object as the subtitles indicating the atmosphere around the imaging object. As an example, in a case where the volume of the voice included in the moving image C1 is equal to or larger than a predetermined threshold value (that is, when there is an excitement), the information processing apparatus 10 generates subtitles indicating the excitement “it's excited” or subtitles indicating an onomatopoeia such as “hustle and bustle”. Furthermore, in a case where the volume of the voice included in the moving image C1 is less than a predetermined threshold value (that is, when there is no excitement), the information processing apparatus 10 generates subtitles indicating no excitement “it's calm” or subtitles indicating an onomatopoeia such as “shin-shin”.

Furthermore, the information processing apparatus 10 may generate subtitles in consideration of information regarding the user U1. For example, the information processing apparatus 10 may generate subtitles of a style corresponding to the attribute information (for example, a demographic attribute or a psychographic attribute) of the user U1. As an example, the information processing apparatus 10 may generate subtitles by inputting, to the model #1, explanatory information of the moving image C1, attribute information of the user U1, a rule defining generation of subtitles with a style according to the attribute information of the user U1, and an instruction sentence for instructions to generate the subtitles on the basis of the explanatory information of the moving image C1 according to the rule.

Furthermore, the information processing apparatus 10 may generate subtitles in consideration of purpose for which the user U1 has imaged the moving image C1. For example, the information processing apparatus 10 may generate subtitles of a style corresponding to the purpose for which the user U1 has captured the moving image C1 (for example, so-called “sponsored video” captured as an advertisement project, “private” capturing the private life of the user U1, or the like). As a specific example, the information processing apparatus 10 may generate subtitles by inputting, to the model #1, explanatory information of the moving image C1, a purpose for which the user U1 has captured the moving image C1, a rule defining generation of subtitles with a style according to the purpose, and an instruction sentence for instructions to generate the subtitles on the basis of the explanatory information of the moving image C1 according to the rule. As an example, if the purpose of capturing the moving image C1 by the user U1 is “sponsored video”, the information processing apparatus 10 generates subtitles of polite words. Furthermore, if the purpose of capturing the moving image C1 by the user U1 is “private”, subtitles using broken expression may be generated.

In addition, the information processing apparatus 10 may receive a request (rule) of the user U1 regarding the subtitles and generate the subtitles according to the received request. As an example, the information processing apparatus 10 may generate subtitles by inputting, to the model #1, explanatory information of the moving image C1, the request of the user U1, a rule defining generation of subtitles according to the request, and an instruction sentence for instructions to generate the subtitles on the basis of the explanatory information of the moving image C1 according to the rule. As an example, the request of the user U1 may be “wishing to show the name of the store #1 in subtitles”, “wishing not to show specific position information”, or the like.

Subsequently, the information processing apparatus 10 presents the generated subtitles T1, T2, T3, . . . to the user U1 via the user terminal 100 (step S4). For example, the information processing apparatus 10 presents the subtitles T1, T2, T3, . . . as candidates of the subtitles to be applied to the moving image C1.

Here, in the example of FIG. 1, it is assumed that the user U1 desires to apply a corrected subtitles of the subtitles T2 as the subtitles of the moving image C1. In such a case, the information processing apparatus 10 receives correction information indicating correction content for the subtitles T2 from the user terminal 100 via the moving image editing service (step S5). For example, the information processing apparatus 10 receives, from the user U1, the correction information for the subtitles T2 in a conversation form in which an answer corresponding to the message input by the user U1 is output using generative artificial intelligence (AI).

Subsequently, the information processing apparatus 10 corrects the subtitles T2 on the basis of the correction information (step S6). Here, it is assumed that the correction information instructs to change the font of the subtitles T2 to the font specified by the user U1. In such a case, the information processing apparatus 10 generates subtitles T21 using the font changed from the font of the subtitles T2 to the font specified by the user U1.

Note that the information processing apparatus 10 may correct the subtitles T2 by inputting, to the model #1, the subtitles T2, correction information indicating an image of correction, a rule defining correction of the subtitles T2 according to the correction information, and an instruction sentence for instructions to correct the distribution mode based on the correction information according to the rule. Here, the correction information may be, for example, information indicating an image of correction such as “wishing to make the font look fun”, “wishing to make the color of the subtitles outstanding”, or the like.

Subsequently, the information processing apparatus 10 applies subtitles T21 to the moving image C1 (step S7). For example, the information processing apparatus 10 applies the subtitles T21 to the moving image C1 to generate a moving image SC1.

Note that the information processing apparatus 10 may apply the subtitles T21 to a preset position (for example, a lower region of moving image C1), or may apply the subtitles T21 to the position designated by the user U1.

In addition, the information processing apparatus 10 may apply, to the moving image C1, a plurality of subtitles selected by the user U1 among the subtitles obtained by correcting the subtitles T1, T2, T3, . . . and the subtitles T1, T2, T3, . . . .

Subsequently, the information processing apparatus 10 provides the moving image SC1 to the user terminal 100 via the moving image editing service (step S8). For example, the information processing apparatus 10 provides data of the moving image SC1 to the user terminal 100.

Note that the information processing apparatus 10 may provide information indicating subtitles (for example, text information) to the user terminal 100. Then, the user U1 may apply the provided subtitles to the moving image C1 using moving image editing software or the like installed in the user terminal 100.

As described above, the information processing apparatus 10 according to the embodiment generates the subtitles to be applied to the moving image on the basis of the explanatory information describing the content of the moving image. As a result, the information processing apparatus 10 according to the embodiment can generate and apply appropriate subtitles for the content of the moving image.

Furthermore, in recent years, moving images have been actively posted by users in SNS and the like, and techniques for providing subtitles to such moving images have been proposed. However, the conventional technique merely performs voice recognition of a moving image and automatically displays subtitles of the voice, and does not disclose providing subtitles indicating an imaging object, a state of mind of the imaging object, a situation of the imaging object, and the like in consideration of content (context) of the moving image.

Therefore, according to the information processing apparatus 10 according to the embodiment, it is possible to apply subtitles indicating an imaging object, a state of mind of the imaging object, a situation of the imaging object, and the like in consideration of the content of the moving image, and thus, it is possible to save time and effort for the user to consider the subtitles from scratch and improve convenience.

### 2. Other Processing Examples

Note that the above-described processing is merely an example, and the information processing apparatus 10 may perform various types of processing using various types of information. In this regard, the following examples are listed.

### 2-1. Display Mode of Subtitles

In the example of FIG. 1, the information processing apparatus 10 may generate subtitles in various display modes. For example, the information processing apparatus 10 may set the subtitles T1 “tapioca of the store #1 in the area #1” indicating the imaging object OB3 to a color corresponding to the imaging object OB3 (for example, brown color inspired by “tapioca”). Furthermore, the information processing apparatus 10 may set subtitles indicating an affirmative feeling of the imaging object, a situation inducing an affirmative feeling in the imaging object, and the like (for example, subtitles T2 “looks delicious!”) to a color with high brightness. Furthermore, the information processing apparatus 10 may set subtitles indicating a negative feeling of the imaging object, a situation inducing a negative feeling in the imaging object, and the like (for example, subtitles T3 “Oops, stumbled”) to a color with low brightness. Note that the information processing apparatus 10 may determine the color of the subtitles on the basis of the feeling of the imaging object OB2 estimated from the voice SD1, the expression of the imaging object OB2, or the like.

Furthermore, the information processing apparatus 10 may set subtitles indicating an affirmative feeling of the imaging object, a situation of inducing an affirmative feeling in the imaging object, and the like using a catchy font. Furthermore, the information processing apparatus 10 may set subtitles indicating a negative feeling of the imaging object, a situation inducing a negative feeling in the imaging object, and the like using a font with a dark impression. Note that the information processing apparatus 10 may determine the font of the subtitles on the basis of the feeling of the imaging object OB2 estimated from the voice SD1, the expression of the imaging object OB2, or the like.

Furthermore, the information processing apparatus 10 may make the size of the subtitles indicating the affirmative feeling of the imaging object, the situation inducing the affirmative feeling in the imaging object, and the like larger than usual (in other words, compared to subtitles not indicating the affirmative feeling or the situation inducing the affirmative feeling in the imaging object, or the like.). Furthermore, the information processing apparatus 10 may make the size of the subtitles indicating the negative feeling of the imaging object, the situation of inducing the negative feeling in the imaging object, and the like smaller than usual (in other words, compared to subtitles not indicating the negative feeling or the situation inducing the negative feeling in the imaging object, or the like.). Note that the information processing apparatus 10 may determine the size of the subtitles on the basis of the feeling of the imaging object OB2 estimated from the voice SD1, the expression of the imaging object OB2, or the like.

Furthermore, the information processing apparatus 10 may set a motion in the subtitles depending on whether it indicates an affirmative feeling of the imaging object, a situation inducing an affirmative feeling in the imaging object, or the like, or indicates a negative feeling of the imaging object, a situation inducing the negative feeling in the imaging object, or the like. Furthermore, the information processing apparatus 10 may set, for the subtitles, a motion corresponding to a situation (operation) of the imaging object indicated by the subtitles. For example, the information processing apparatus 10 may set a motion (for example, a tilting motion) imaging a stumble for the subtitles T3 “Oops, stumbled”.

### 3. Configuration of Information Processing Apparatus

Next, a configuration of the information processing apparatus 10 will be described with reference to FIG. 2. FIG. 2 is a diagram illustrating a configuration example of the information processing apparatus 10 according to the embodiment. As illustrated in FIG. 2, the information processing apparatus 10 includes a communication unit 20, a storage unit 30, and a control unit 40.

### Communication Unit 20

The communication unit 20 is implemented by, for example, a network interface card (NIC) or the like. Then, the communication unit 20 is connected to the network N in a wired or wireless manner, and transmits and receives information to and from the user terminal 100, for example.

### (Storage Unit 30)

The storage unit 30 is implemented by, for example, a semiconductor memory element such as a random access memory (RAM) or a flash memory, or a storage device such as a hard disk or an optical disk. As illustrated in FIG. 2, the storage unit 30 includes a moving image information database 31 and a model database 32.

### (Moving Image Information Database 31)

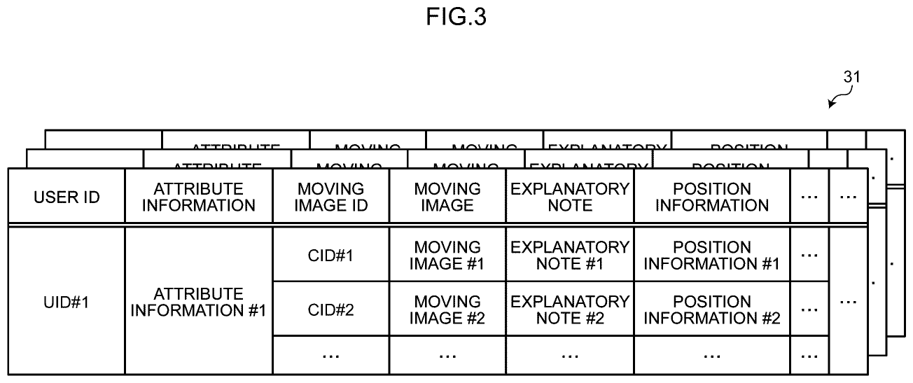

The moving image information database 31 stores various types of information regarding moving images (for example, the explanatory information describing the content of the moving image). Here, an example of information stored in the moving image information database 31 will be described with reference to FIG. 3. FIG. 3 is a diagram illustrating an example of the moving image information database 31. In the example of FIG. 3, the moving image information database 31 includes items such as “user ID”, “attribute information”, “moving image ID”, “moving image”, “explanatory note”, and “position information”.

The “user ID” indicates identification information for identifying a user. The “attribute information” indicates a demographic attribute or a psychographic attribute of the user. The “moving image ID” indicates identification information for identifying a moving image provided by the user (for example, a moving image captured by a user). The “moving image” indicates a moving image provided by the user. The “explanatory note” indicates an explanatory note input by the user for the moving image. The “position information” indicates position information when a moving image is captured (for example, the position information measured by the user terminal 100 that has captured the moving image).

That is, FIG. 3 illustrates an example in which the attribute information of the user identified by the user ID “UID #1” is “attribute information #1”, the moving image “moving image #1” provided by the user is identified by the moving image ID “CID #1”, the explanatory note is “explanatory note #1”, and the position information is “position information #1”.

Note that the information stored in the moving image information database 31 is not limited to the above information. For example, the moving image information database 31 may store the purpose of capturing moving image C1, information indicating an imaging object, text information indicating a voice included in the moving image, and the like. Furthermore, the moving image information database 31 may store text information indicating an expression of the imaging object, an operation of the imaging object, a physical body held by the imaging object, a character string included in the moving image, and the like.

### (Model Database 32)

The model database 32 stores a model that has been trained so as to generate an answer to an input question.

### Control Unit 40

The control unit 40 is a controller, and is implemented by, for example, a central processing unit (CPU) or a micro processing unit (MPU) executing various programs stored in a storage device inside the information processing apparatus 10 using a RAM as a work area. Furthermore, the control unit 40 is a controller, and may be implemented by, for example, an integrated circuit such as an application specific integrated circuit (ASIC), or a field programmable gate array (FPGA). As illustrated in FIG. 2, the control unit 40 according to the embodiment includes an acquisition unit 41, a generation unit 42, a reception unit 43, a correction unit 44, and an application unit 45, and implements or executes a function and an action of information processing described below.

### (Acquisition Unit 41)

The acquisition unit 41 acquires the explanatory information describing the content of the moving image. For example, in the example of FIG. 1, the acquisition unit 41 acquires the moving image C1 and the explanatory information describing the content of the moving image C1 from the user terminal 100 via the moving image editing service, and stores the acquired information in the storage unit 30 (for example, the moving image information database 31).

### Generation Unit 42

The generation unit 42 generates subtitles to be applied to the moving image on the basis of the explanatory information acquired by the acquisition unit 41. For example, in the example of FIG. 1, the generation unit 42 refers to the storage unit 30 (for example, the moving image information database 31), and generates subtitles to be applied to the moving image C1 on the basis of the explanatory information of the moving image C1.

Further, the generation unit 42 may generate subtitles indicating an imaging object of the moving image. For example, in the example of FIG. 1, the generation unit 42 generates subtitles T1 “tapioca of the store #1 in the area #1” indicating the information related to the imaging object OB3 on the basis of the explanatory information, such as the positional information at the time of imaging the moving image C1, the text information indicating the voice SD1 uttered by the user U1, the character string “store #1” indicated by the signboard of the store #1, the text information “I've come to drink tapioca today” indicating the voice SD1, and the like.

In addition, the generation unit 42 may generate subtitles indicating a state of mind of the imaging object of the moving image. For example, in the example of FIG. 1, the generation unit 42 generates subtitles T2 “looks delicious!” indicating the state of mind of the imaging object OB2 on the basis of the explanatory information such as the expression of the imaging object OB2 and the text information “I've come to drink tapioca today” indicating the voice SD1.

In addition, the generation unit 42 may generate subtitles indicating a situation of the imaging object of the moving image. For example, in the example of FIG. 1, the generation unit 42 generates subtitles T3 “Oops, stumbled” indicating a situation of the imaging object OB2 on the basis of the explanatory information indicating an operation of the imaging object OB2.

In addition, the generation unit 42 may generate subtitles in a display mode according to the imaging object of the moving image. For example, in the example of FIG. 1, the generation unit 42 sets the subtitles T1 “tapioca of the store #1 in the area #1” indicating the imaging object OB3 to a color corresponding to the imaging object OB3.

In addition, the generation unit 42 may generate subtitles in a display mode according to a state of mind of the imaging object of the moving image. For example, in the example of FIG. 1, the generation unit 42 sets the subtitles indicating the affirmative feeling of the imaging object to a color with high brightness. In addition, the generation unit 42 sets the subtitles indicating the negative feeling of the imaging object to a color with low brightness. In addition, the generation unit 42 sets the subtitles indicating the affirmative feeling of the imaging object using a catchy font. In addition, the generation unit 42 sets the subtitles indicating the negative feeling of the imaging object using a font with a dark impression. In addition, the generation unit 42 makes the size of the subtitles indicating the affirmative feeling of the imaging object larger than usual. In addition, the generation unit 42 makes the size of the subtitles indicating the negative feeling of the imaging object smaller than usual. In addition, the generation unit 42 sets a motion in the subtitles according to whether the subtitles indicate an affirmative feeling of the imaging object or a negative feeling of the imaging object.

In addition, the generation unit 42 may generate subtitles in a display mode according to the situation of the imaging object of the moving image. For example, in the example of FIG. 1, the generation unit 42 sets the subtitles indicating a situation inducing an affirmative feeling in the imaging object to a color with high brightness. In addition, the generation unit 42 sets the subtitles indicating a situation inducing a negative feeling in the imaging object to a color with low brightness. In addition, the generation unit 42 sets the subtitles indicating a situation inducing an affirmative feeling in the imaging object using a catchy font. In addition, the generation unit 42 sets the subtitles indicating a situation inducing a negative feeling in the imaging object using a font with a dark impression. In addition, the generation unit 42 makes the size of the subtitles indicating a situation inducing an affirmative feeling in the imaging object larger than usual. In addition, the generation unit 42 makes the size of the subtitles indicating a situation inducing a negative feeling in the imaging object smaller than usual. In addition, the generation unit 42 sets a motion in the subtitles according to whether the subtitles indicate a situation inducing an affirmative feeling in the imaging object or a situation inducing a negative feeling in the imaging object. In addition, the generation unit 42 sets a motion assumed to stumble for the subtitles T3 “Oops, stumbled”.

Furthermore, the generation unit 42 may generate subtitles by inputting explanatory information and an instruction sentence instructing to output subtitles of a moving image on the basis of the explanatory information to a model trained to output an answer to an input question. For example, in the example of FIG. 1, the generation unit 42 refers to the storage unit 30 (for example, the moving image information database 31, the model database 32, and the like), and generates subtitles to be applied to the moving image C1 using the explanatory information of the moving image C1 and the model #1 trained to generate an answer to the input question.

Furthermore, the generation unit 42 may generate subtitles by inputting, to the model, the explanatory information, a rule specified by the provider of the moving image, and an instruction sentence for instructions to output the subtitles of the moving image according to the rule on the basis of the explanatory information. For example, in the example of FIG. 1, the generation unit 42 may generate subtitles by inputting, to the model #1, explanatory information of the moving image C1, the request of the user U1, a rule defining generation of subtitles according to the request, and an instruction sentence for instructions to generate the subtitles on the basis of the explanatory information of the moving image C1 according to the rule.

Further, the generation unit 42 may generate a plurality of subtitles to be applied to the moving image. For example, in the example of FIG. 1, the generation unit 42 generates subtitles T1, T2, T3, . . . to be applied to the moving image C1.

Furthermore, the generation unit 42 may generate back ground music (BGM) to be added to the moving image on the basis of the acquired explanatory information and/or additional information. For example, in a case where information regarding a text or voice of “tapioca” or information regarding a tapioca shop as additional information has been acquired, the generation unit 42 may generate and apply background music that images tapioca (for example, a pop tune or a tune imitating a southern country).

Note that the generation unit that generates background music and the generation unit 42 that generates subtitles described above are not necessarily physically the same. For example, the background music generated here is generated by a server device (not illustrated) different from the information processing apparatus 10, and acquisition of the background music generated by the different server device by the information processing apparatus 10 (the generation unit 42) is also included in the generation of the background music. Furthermore, the background music generated here is not necessarily background music mechanically generated using AI or the like, and may be, for example, a copyright free sound source that can be acquired on the Internet.

### Reception Unit 43

The reception unit 43 receives the correction information indicating the correction content for the subtitles from the provider of the moving image. For example, in the example of FIG. 1, the reception unit 43 receives correction information indicating correction content for the subtitles T2 from the user terminal 100 via the moving image editing service.

Furthermore, the reception unit 43 may receive the correction information in a conversation form with the provider. For example, in the example of FIG. 1, the reception unit 43 receives the correction information for the subtitles T2 from the user U1 in a conversation form in which an answer corresponding to the message input by the user U1 is output using generative AI.

### Correction Unit 44

The correction unit 44 corrects the subtitles on the basis of the correction information received by the reception unit 43. For example, in the example of FIG. 1, the correction unit 44 corrects the subtitles T2 on the basis of the correction information received from the user terminal 100.

Furthermore, the correction unit 44 may correct subtitles by inputting correction information, subtitles, and an instruction sentence for instructions to correct the subtitles on the basis of the correction information to a model trained to output an answer to an input question.

For example, in the example of FIG. 1, the correction unit 44 refers to the storage unit 30 (for example, the model database 32, or the like), and corrects the subtitles T2 by inputting, to the model #1, the subtitles T2, correction information indicating an image of correction, a rule defining correction of the subtitles T2 according to the correction information, and an instruction sentence for instructions to correct the distribution mode based on the correction information according to the rule.

### Application Unit 45

The application unit 45 applies subtitles generated by the generation unit 42 to the moving image. For example, in the example of FIG. 1, the application unit 45 applies the subtitles T21 to the moving image C1 to generate a moving image SC1.

Further, the application unit 45 may apply, to the moving image, subtitles selected by the provider of the moving image among the plurality of subtitles. For example, in the example of FIG. 1, the application unit 45 applies, to the moving image C1, a plurality of subtitles selected by the user U1 from among the subtitles T1, T2, T3, . . . .

Further, the application unit 45 may apply the subtitles corrected by the correction unit 44 to the moving image. For example, in the example of FIG. 1, the application unit 45 applies the subtitles T21 corrected by the correction unit 44 to the moving image C1.

### 4. Procedure of Information Processing

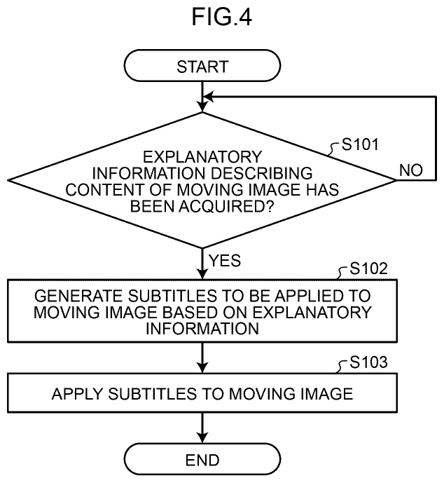

A procedure of information processing of the information processing apparatus 10 according to the embodiment will be described with reference to FIG. 4. FIG. 4 is a flowchart illustrating an example of a procedure of the information processing according to the embodiment.

As illustrated in FIG. 4, the information processing apparatus 10 determines whether or not the explanatory information describing the content of the moving image has been acquired (step S101). In a case where the explanatory information has not been acquired (step S101: No), the information processing apparatus 10 waits until acquiring the explanatory information.

On the other hand, in a case where the explanatory information has been acquired (step S101: Yes), the information processing apparatus 10 generates subtitles to be applied to the moving image on the basis of the explanatory information (step S102). Subsequently, the information processing apparatus 10 applies subtitles to the moving image (step S103), and ends the processing.

### 5. Modification

The above-described embodiments are examples, and various modifications and applications are possible.

### 5-1. Processing Mode

Among the processing described in the above embodiments, all or a part of the processing described as being automatically performed can be manually performed, and conversely, all or a part of the processing described as being manually performed can be automatically performed by a known method. In addition, the processing procedures, specific names, and information including various data and parameters illustrated in the description and the drawings can be arbitrarily changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like.

In addition, the above-described embodiments can be appropriately combined within a range in which the processing contents do not contradict each other.

### 6. Effects

As described above, the information processing apparatus 10 according to the embodiment includes the acquisition unit 41, the generation unit 42, the reception unit 43, the correction unit 44, and the application unit 45. The acquisition unit 41 acquires the explanatory information describing the content of the moving image. The generation unit 42 generates subtitles to be applied to the moving image on the basis of the explanatory information acquired by the acquisition unit 41. Furthermore, the generation unit 42 generates subtitles by inputting explanatory information and an instruction sentence for instructions to output subtitles of a moving image on the basis of the explanatory information to a model trained to output an answer to an input question. Furthermore, the generation unit 42 generates subtitles by inputting, to the model, the explanatory information, a rule specified by the provider of the moving image, and an instruction sentence for instructions to output the subtitles of the moving image according to the rule on the basis of the explanatory information. The reception unit 43 receives the correction information indicating the correction content for the subtitles from the provider of the moving image. Furthermore, the reception unit 43 receives the correction information in a conversation form with the provider. The correction unit 44 corrects the subtitles on the basis of the correction information received by the reception unit 43. Furthermore, the correction unit 44 corrects subtitles by inputting correction information, subtitles, and an instruction sentence for instructions to correct the subtitles on the basis of the correction information to a model trained to output an answer to an input question. The application unit 45 applies subtitles generated by the generation unit 42 to the moving image. Further, the application unit 45 applies, to the moving image, subtitles selected by the provider of the moving image among the plurality of subtitles. Further, the application unit 45 applies the subtitles corrected by the correction unit 44 to the moving image.

As a result, the information processing apparatus 10 according to the embodiment can generate subtitles to be applied to the moving image on the basis of the explanatory information describing the content of the moving image, and thus, can generate and apply appropriate subtitles to the content of the moving image.

Furthermore, in the information processing apparatus 10 according to the embodiment, for example, the generation unit 42 generates subtitles indicating an imaging object of a moving image. In addition, the generation unit 42 generates subtitles indicating a state of mind of the imaging object of the moving image. In addition, the generation unit 42 generates subtitles indicating a situation of the imaging object of the moving image. In addition, the generation unit 42 generates subtitles in a display mode according to the imaging object of the moving image. In addition, the generation unit 42 generates subtitles in a display mode according to the state of mind of the imaging object of the moving image. In addition, the generation unit 42 generates subtitles in a display mode according to the situation of the imaging object of the moving image. Furthermore, the generation unit 42 generates subtitles by inputting explanatory information and an instruction sentence for instructions to output subtitles of a moving image on the basis of the explanatory information to a model trained to output an answer to an input question. Furthermore, the generation unit 42 generates subtitles by inputting, to the model, the explanatory information, a rule specified by the provider of the moving image, and an instruction sentence for instructions to output the subtitles of the moving image according to the rule on the basis of the explanatory information.

As a result, the information processing apparatus 10 according to the embodiment can generate subtitles of various modes and apply the generated subtitles to a moving image, and thus, can improve convenience.

### 7. Hardware Configuration

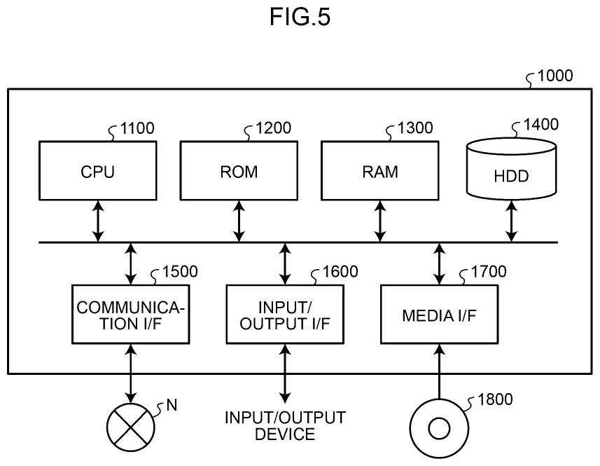

Furthermore, the information processing apparatus 10 according to the above-described embodiments is implemented by a computer 1000 having a configuration as illustrated in FIG. 5, for example. Hereinafter, the information processing apparatus 10 will be described as an example. FIG. 5 is a hardware configuration diagram illustrating an example of a computer that implements the functions of the information processing apparatus 10. The computer 1000 includes a CPU 1100, a ROM 1200, a RAM 1300, an HDD 1400, a communication interface (I/F) 1500, an input/output interface (I/F) 1600, and a media interface (I/F) 1700.

The CPU 1100 operates on the basis of a program stored in the ROM 1200 or the HDD 1400, and controls each unit. The ROM 1200 stores a boot program executed by the CPU 1100 when the computer 1000 is activated, a program depending on hardware of the computer 1000, and the like.

The HDD 1400 stores a program executed by the CPU 1100, data used by the program, and the like. The communication interface 1500 receives data from another device via a communication network 500 (corresponding to the network N of the embodiment) and sends the data to the CPU 1100, and transmits data generated by the CPU 1100 to another device via the communication network 500.

The CPU 1100 controls an output device such as a display or a printer and an input device such as a keyboard or a mouse via the input/output interface 1600. The CPU 1100 acquires data from the input device via the input/output interface 1600. In addition, the CPU 1100 outputs the generated data to the output device via the input/output interface 1600.

The media interface 1700 reads a program or data stored in a recording medium 1800 and provides the program or data to the CPU 1100 via the RAM 1300. The CPU 1100 loads the program from the recording medium 1800 onto the RAM 1300 via the media interface 1700, and executes the loaded program. Note that the recording medium 1800 is, for example, an optical recording medium such as a digital versatile disc (DVD), or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 10, the CPU 1100 of the computer 1000 realizes the function of the control unit 40 by executing the program loaded on the RAM 1300. In addition, each data in the storage device of the information processing apparatus 10 is stored in the HDD 1400. The CPU 1100 of the computer 1000 reads and executes these programs from the recording medium 1800, but as another example, these programs may be acquired from another device via a predetermined communication network.

### 8. Others

Although some of the embodiments of the present application have been described in detail with reference to the drawings, these are merely examples, and the present invention can be implemented in other forms subjected to various modifications and improvements based on the knowledge of those skilled in the art, including the aspects described in the disclosure of the invention.

Furthermore, the configuration of the information processing apparatus 10 described above can be flexibly changed, for example, by calling an external platform or the like with an application programming interface (API), network computing, or the like depending on the function.

In addition, “units” described in the claims can be replaced with “means”, “circuit”, or the like. For example, a reception unit can be replaced with a reception means or a reception circuit.

According to one aspect of an embodiment, it is possible to generate and provide appropriate subtitles for the content of the moving image.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an acquisition unit configured to acquire explanatory information describing content of a moving image;
a generation unit configured to generate subtitles to be applied to the moving image based on the explanatory information acquired by the acquisition unit; and
an application unit configured to apply the subtitles generated by the generation unit to the moving image.

2. The information processing apparatus according to claim 1, wherein
the generation unit
generates the subtitles indicating an imaging object of the moving image.

3. The information processing apparatus according to claim 1, wherein
the generation unit
generates the subtitles indicating a state of mind of an imaging object of the moving image.

4. The information processing apparatus according to claim 1, wherein
the generation unit
generates the subtitles indicating a situation of an imaging object of the moving image.

5. The information processing apparatus according to claim 1, wherein
the generation unit
generates the subtitles in a display mode according to an imaging object of the moving image.

6. The information processing apparatus according to claim 1, wherein
the generation unit
generates the subtitles in a display mode according to a state of mind of an imaging object of the moving image.

7. The information processing apparatus according to claim 1, wherein
the generation unit
generates the subtitles in a display mode according to a situation of an imaging object of the moving image.

8. The information processing apparatus according to claim 1, wherein
the generation unit
generates the subtitles by inputting the explanatory information and an instruction sentence for instruction to output the subtitles of the moving image based on the explanatory information to a model trained to output an answer to an input question.

9. The information processing apparatus according to claim 8, wherein
the generation unit
generates the subtitles by inputting, to the model, the explanatory information, a rule specified by a provider of the moving image, and an instruction sentence for instruction to output the subtitles of the moving image according to the rule based on the explanatory information.

10. The information processing apparatus according to claim 1, wherein
the generation unit
generates a plurality of the subtitles to be applied to the moving image, and
the application unit
applies, to the moving image, the subtitles selected by the provider of the moving image among the plurality of subtitles.

11. The information processing apparatus according to claim 1, further comprising:
a reception unit configured to receive, from the provider of the moving image, correction information indicating correction content for the subtitles; and
a correction unit configured to correct the subtitles based on the correction information received by the reception unit, wherein
the application unit
applies the subtitles corrected by the correction unit to the moving image.

12. The information processing apparatus according to claim 11, wherein
the correction unit
corrects the subtitles by inputting the correction information, the subtitles, and an instruction sentence for instruction to correct the subtitles based on the correction information to a model trained to output an answer to an input question.

13. The information processing apparatus according to claim 11, wherein
the reception unit
receives the correction information in a conversation form with the provider.

14. An information processing method executed by a computer, the method comprising the steps of:
acquiring explanatory information describing content of a moving image;
generating subtitles to be applied to the moving image based on the explanatory information acquired by the acquiring step; and
applying the subtitles generated by the generating step to the moving image.

15. A non-transitory computer readable storage medium having stored therein an information processing program causing a computer to execute procedures of:
acquiring explanatory information describing content of a moving image;
generating subtitles to be applied to the moving image based on the explanatory information acquired by the acquiring procedure; and
applying subtitles generated by the generating procedure to the moving image.
